(19) United States
(12) Patent Application Publication
(10) Pub. No.: US 2013/0089275 A1
(43) Pub. Date: Apr. 11, 2013

(54) RESEALABLE AND DISPOSABLE ZIPPERS FOR NON-RESEALABLE BAGS

(71) Applicant: Manuel Montoya, Miami, FL (US)

(72) Inventor: Manuel Montoya, Miami, FL (US)

(21) Appl. No.: 13/270,368

(22) Filed: Oct. 11, 2011

(51) Int. Cl. B65D 33/16; B31B 41/00

(52) U.S. Cl. 383/42; 493/210

(57) ABSTRACT

An apparatus for providing re-sealability to a conventional bag is disclosed. The apparatus includes a first strip of plastic having disposed on one side a first half of a plastic zipper and an adhesive and a second strip of plastic having disposed on one side a second half of a plastic zipper and an adhesive. The adhesive of the first and second strips may be applied to an opening of the conventional bag such that the first and second halves of the plastic zipper align so as to provide a re-sealing opening to the bag.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to plastic containers, and more particularly to disposable plastic containers that cannot be resealed.

### BACKGROUND OF THE INVENTION

Many disposable plastic bags, such as a potato chip bag, cannot be resealed. A potato chip bag comprises a sealed plastic bag that may be opened along the top seam to allow a consumer access to the potato chips within the bag. When the consumer is finished eating from the bag, however, there is often a need to reseal the bag so that the remaining food within the bag can be stored for later consumption. A conventional food bag, however, does not provide any mechanism for allowing the bag to be resealed along the top seam or anywhere else.

One of the current solutions to this problem is to roll up the bag starting at the top and moving towards the bottom of the bag. This is not an adequate solution, however, because the material from which disposable bags are sometimes made has a level of rigidity that enables the material to unroll over time. Once unrolled, the interior contents of the bag are open to the elements and can result in a negative outcome, such as stale or spoiled food. Another current solution to the aforementioned problem involves using a reusable clip, similar to a binder clip. This solution entails rolling up the top portion of the bag and placing the clip around the rolled portion to hold it in place. This keeps the rolled portion of the bag in its current position until unclipped at a later time when the interior of the bag must be accessed. One of the drawbacks to this solution, however, is that the clip must be removed each time accessed is desired and the clip must be stored somewhere that can later be found when the bag is resealed later. During this period of time, however, clips can be misplaced or lost and the user is left with no apparatus for resealing his plastic bag when it comes time to reseal the bag.

Therefore, there is a need to traverse the deficiencies in the art and more particularly there is a need for a more efficient method and apparatus for resealing plastic bags that do not come with a resealing feature.

### SUMMARY OF THE INVENTION

Briefly, in accordance with one embodiment of the present invention, an apparatus for providing re-sealability to a conventional bag is disclosed. The apparatus includes a first strip of plastic having disposed on one side a first half of a plastic zipper and an adhesive and a second strip of plastic having disposed on one side a second half of a plastic zipper and an adhesive. The adhesive of the first and second strips may be applied to an opening of the conventional bag such that the first and second halves of the plastic zipper align so as to provide a re-sealing opening to the bag.

In another embodiment of the present invention, an alternative apparatus for providing re-sealability to a conventional bag is disclosed. The apparatus includes a first strip of plastic having disposed on one side a first half of a plastic zipper, an adhesive below the plastic zipper and a removable strip over the adhesive and a second strip of plastic having disposed on one side a second half of a plastic zipper, an adhesive below the plastic zipper and a removable strip over the adhesive. The apparatus further includes a first seam that connects a first end of the first strip to a first send of the second strip and a second seam that connects a second end of the second strip to the second end of the second strip. When the removable strips are removed, the adhesive of the first and second strips may be applied to an opening of the conventional bag such that the first and second halves of the plastic zipper align so as to provide a re-sealing opening to the bag.

In another embodiment of the present invention, a method for providing re-sealability to a conventional bag is disclosed. The method includes removing a removable strip placed over an adhesive disposed on one side of a first strip of plastic, wherein the first strip further includes a first half of a plastic zipper located on the same side of the first strip above the adhesive and removing a removable strip placed over an adhesive disposed on one side of a second strip of plastic, wherein the second strip further includes a second half of a plastic zipper located on the same side of the second strip above the adhesive. The method further includes applying the adhesive of the first strip to one side of an opening of the conventional bag such that the first half of the plastic zipper extends past the opening of the bag and applying the adhesive of the second strip to another side of an opening of the conventional bag such that the second half of the plastic zipper extends past the opening of the bag, and such that the first and second halves of the plastic zipper align so as to provide a re-sealing opening to the bag.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 shows a perspective view of an apparatus for providing re-sealability to a conventional bag, according to one embodiment of the present invention.

FIG. 2 shows a perspective view of the apparatus of FIG. 1 showing removal of the removable strips.

FIG. 3 shows a perspective view of the apparatus of FIG. 1 prior to attachment to a conventional non-re-sealable bag.

FIG. 4 shows a perspective view of the apparatus of FIG. 1 after application to a conventional non-re-sealable bag.

FIG. 5 shows a perspective view of the apparatus of FIG. 1 after application to a conventional non-re-sealable bag and sealing of the plastic zipper.

### DETAILED DESCRIPTION

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing like numerals refer to like parts through several views.

The present invention, according to a preferred embodiment, overcomes problems with the prior art by providing a disposable and re-sealable plastic zipper apparatus that can be attached to a conventional plastic bag that is not re-sealable. This allows a consumer to convert a non-re-sealable conventional plastic bag to a re-sealable plastic bag. Further, since the apparatus of the invention is attached to the conventional plastic bag, the apparatus of the invention need not be removed and then found again later.

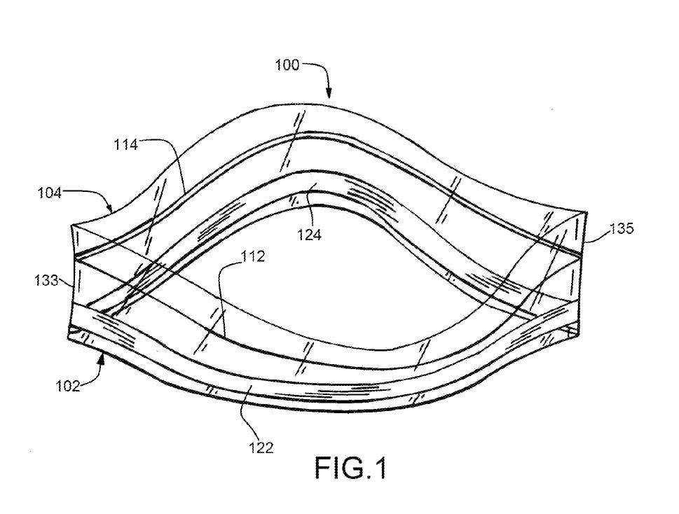

FIG. 1 shows a perspective view of an apparatus 100 for providing re-sealability to a conventional bag, according to one embodiment of the present invention. FIG. 1 shows a first strip 102 of transparent plastic and a second strip 104 of transparent plastic, wherein the two strips 102, 104 are connected at a first end by a first seam 133 and the two strips 102, 104 are connected at a second end by a second seam 135. The first strip 102 has various features disposed on its interior side. Those features include a first half of a plastic zipper 112, an adhesive (not shown) below the plastic zipper 112 and a removable strip 122 placed over the adhesive. The second strip 104 also has various features disposed on its interior side. Those features include a second half of a plastic zipper 114, an adhesive (not shown) below the plastic zipper 114 and a removable strip 124 placed over the adhesive.

Note that the features located on the interior surface of first strip 102 are visible in FIG. 1 because the first strip 102 is comprised of transparent plastic. Likewise, the features located on the interior surface of second strip 104 that are occluded by the first strip 102 (near the seams 133, 135) are also visible in FIG. 1 because the first strip 102 is transparent. In one embodiment of the present invention, seams 133 and 135 do not exist and the ends of the apparatus 100 are unattached and move freely.

In this disclosure, the term plastic zipper refers to the combination of the zipper halves 112, 114, which comprise two sides of a plastic zipper, as is well known in the art for re-sealable plastic bags. For example, zipper half 112 may comprise a single ridge that extends from seam 133 to seam 135 and zipper half 114 may comprise two ridges that extend from seam 133 to seam 135 such that the space between the two ridges is such that is allows for the single ridge of 112 to be inserted between the two ridges and cause a friction fit. This coupling between zipper halves 112 and 114 may produce a water and/or air tight seal so as to prevent air and/or water from passing.

Note the adhesive and the removable strip 122 of the first strip 102 extend from the first seam 133 to the second seam 135. Also, the first half of the plastic zipper 112 extends from the first seam 133 to the second seam 135. Further, the adhesive, the removable strip 124 and the second half of the plastic zipper 114 of second strip 104 extends from the first seam 133 to the second seam 135. Further note that the placement of the zipper halves 112 and 114 on the first and second strips 102, 104 are such that the zipper halves 112, 114 are aligned so as to couple with each other when the two strips 102, 104 are pressed against each other. Lastly, note that the placement of the adhesive and removable strip 122 of first strip 102 is aligned with the adhesive and removable strip 124 of second strip 104.

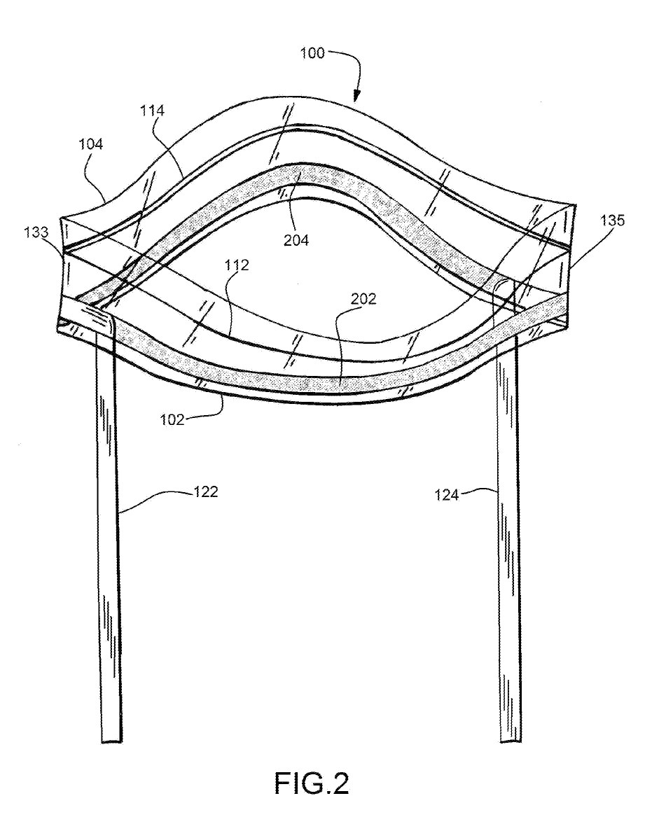

FIG. 2 shows a perspective view of the apparatus 100 of FIG. 1 showing removal of the removable strips 122, 124. FIG. 2 shows that the removal of removable strip 124 has exposed the existence of adhesive 204 underneath the removable strip 124 on second strip 104. Note that adhesive 204 as an identical footprint to removable strip 124 and also extends from seam 133 to seam 135. FIG. 2 also shows that the removal of removable strip 122 has exposed the existence of adhesive 202 underneath the removable strip 122 on first strip 102. Note that adhesive 202 as an identical footprint to removable strip 122 and also extends from seam 133 to seam 135.

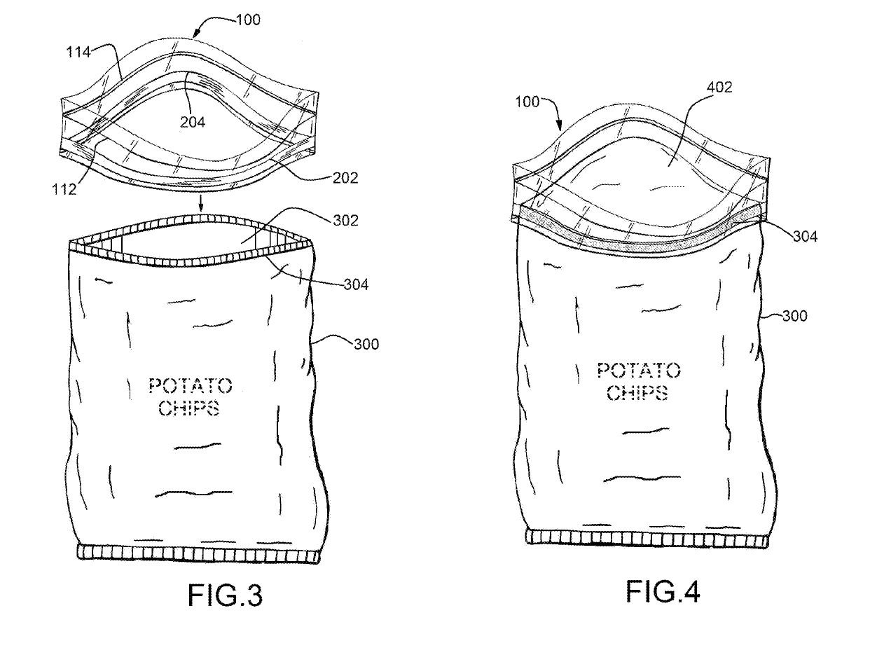

FIG. 3 shows a perspective view of the apparatus 100 of FIG. 1 prior to attachment to a conventional non-re-sealable bag 300. FIG. 3 shows conventional non-resealable bag 300 comprising a plastic bag with an opening 302 wherein 304 depicts the outer surface of the brim of the opening 302. The bag 300 may be a potato chip bag, for example. FIG. 4 shows a perspective view of the apparatus 100 of FIG. 1 after application to the conventional non-re-sealable bag 300. Note that the adhesive 202 has been applied to the frontal exterior surface of the brim 304 of opening 302 of bag 300 and that the adhesive 204 has been applied to the rear exterior surface of the brim 304 of opening 302 of bag 300. Thus, the entire circumference of the exterior surface of the brim 304 of opening 302 of bag 300 has been attached to the interior surfaces (i.e., adhesives 202, 204) of apparatus 100. Note that the opening 402 now provided by the apparatus 100 is similar or identical to the opening 302 of bag 300.

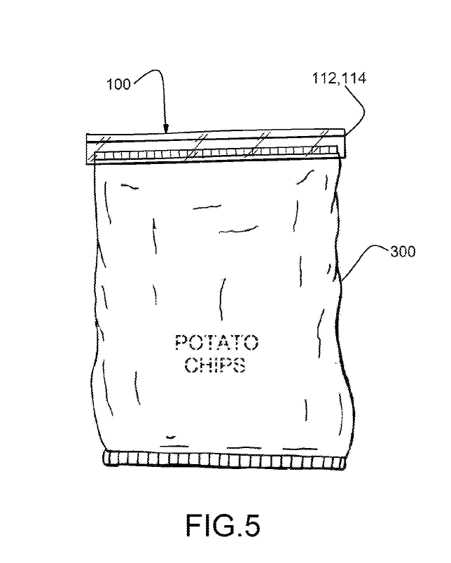

FIG. 5 shows a perspective view of the apparatus 100 of FIG. 1 after application to the conventional non-re-sealable bag 300 and sealing of the plastic zipper, comprising the zipper halves 112, 114. Recall that the placement of the zipper halves 112 and 114 on the first and second strips 102, 104 are such that the zipper halves 112, 114 are aligned so as to couple with each other when the two strips 102, 104 are pressed against each other. FIG. 5 shows that the zipper halves 112, 114 are pressed against each other so as to provide a seal, which may be water and/or air tight. In this fashion, once apparatus 100 has been applied, the opening 302 of the conventional non-re-sealable bag 300 may be re-sealable. Consequently, the conventional non-re-sealable bag 300 may be opened and closed as many times as needed using the plastic zipper, comprising the zipper halves 112, 114, of apparatus 100.

One or more of the components of the apparatus 100 can be manufactured from a flexible or elastic material such as plastic. The apparatus 100 can be made with a variety of plastics films, such as polyethylene (LDPE, LLDPE, etc.). Other materials include polystyrene, PVC, bioplastics, biodegradable plastics, thermoplastics (such as polyethylene, polypropylene, polystyrene, polyvinyl chloride and polytetrafluoroethylene) and thermosetting polymers. Further, it should be noted that the present invention anticipates any size conventional plastic bags, and therefore apparatus 100 may be of any size, shape, height and width.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An apparatus for providing re-sealability to a conventional bag, comprising:
a first strip of plastic having disposed on one side a first half of a plastic zipper and an adhesive; and
a second strip of plastic having disposed on one side a second half of a plastic zipper and an adhesive;
wherein the adhesive of the first and second strips may be applied to an opening of the conventional bag such that the first and second halves of the plastic zipper align so as to provide a re-sealing opening to the bag.

2. The apparatus of claim 1, wherein the adhesive of the first strip is disposed over a length of one side of the first strip and wherein the first half of the plastic zipper is disposed over a length of one side of the first strip.

3. The apparatus of claim 2, wherein the adhesive of the second strip is disposed over a length of one side of the second strip and wherein the second half of the plastic zipper is disposed over a length of one side of the second strip.

4. The apparatus of claim 3, wherein the first half of the plastic zipper is located above the adhesive of the first strip and wherein the second half of the plastic zipper is located above the adhesive of the second strip, such that when the adhesive of the first and second strips is applied to the opening of the conventional bag, the first and second halves of the plastic zipper extend past the opening of the conventional bag.

5. The apparatus of claim 4, wherein the first strip further includes a removable strip disposed over the adhesive of the first strip and wherein the second strip further includes a removable strip disposed over the adhesive of the second strip, such that the removable strips must be removed before the adhesive of the first and second strips is applied to the opening of the conventional bag.

6. The apparatus of claim 5, further comprising a first seam that connects a first end of the first strip to a first send of the second strip.

7. The apparatus of claim 6, further comprising a second seam that connects a second end of the second strip to the second end of the second strip.

8. The apparatus of claim 7, wherein the adhesive of the first strip extends from the first seam to the second seam on one side of the first strip and wherein the first half of the plastic zipper extends from the first seam to the second seam on one side of the first strip.

9. The apparatus of claim 8, wherein the adhesive of the second strip extends from the first seam to the second seam on one side of the second strip and wherein the second half of the plastic zipper extends from the first seam to the second seam on one side of the second strip.

10. An apparatus for providing re-sealability to a conventional bag, comprising:
a first strip of plastic having disposed on one side a first half of a plastic zipper, an adhesive below the plastic zipper and a removable strip over the adhesive;
a second strip of plastic having disposed on one side a second half of a plastic zipper, an adhesive below the plastic zipper and a removable strip over the adhesive;
a first seam that connects a first end of the first strip to a first send of the second strip; and
a second seam that connects a second end of the second strip to the second end of the second strip;
wherein when the removable strips are removed, the adhesive of the first and second strips may be applied to an opening of the conventional bag such that the first and second halves of the plastic zipper align so as to provide a re-sealing opening to the bag.

11. The apparatus of claim 10, wherein the adhesive of the first strip extends from the first seam to the second seam on one side of the first strip and wherein the first half of the plastic zipper extends from the first seam to the second seam on one side of the first strip.

12. The apparatus of claim 11, wherein the adhesive of the second strip extends from the first seam to the second seam on one side of the second strip and wherein the second half of the plastic zipper extends from the first seam to the second seam on one side of the second strip.

13. A method for providing re-sealability to a conventional bag, comprising:
removing a removable strip placed over an adhesive disposed on one side of a first strip of plastic, wherein the first strip further includes a first half of a plastic zipper located on the same side of the first strip above the adhesive;
removing a removable strip placed over an adhesive disposed on one side of a second strip of plastic, wherein the second strip further includes a second half of a plastic zipper located on the same side of the second strip above the adhesive;
applying the adhesive of the first strip to one side of an opening of the conventional bag such that the first half of the plastic zipper extends past the opening of the bag; and
applying the adhesive of the second strip to another side of an opening of the conventional bag such that the second half of the plastic zipper extends past the opening of the bag, and such that the first and second halves of the plastic zipper align so as to provide a re-sealing opening to the bag.

14. The method of claim 13, further comprising coupling the first and second halves of the plastic zipper so as to seal the opening to the conventional bag.
